(19) United States
(12) Patent Application Publication
(10) Pub. No.: US 2016/0031729 A1
(43) Pub. Date: Feb. 4, 2016

(54) WATER TREATMENT METHOD AND MINERAL THEREFOR

(71) Applicant: ZODIAC GROUP AUSTRALIA PTY LTD, Smithfield, New South Wales (AU)

(72) Inventor: Ty Gerard Hermans, Clontarf, Queensland (AU)

(21) Appl. No.: 14/783,721

(22) PCT Filed: Apr. 14, 2014
(86) PCT No.: PCT/AU2014/000428

§ 371 Date: Oct. 9, 2015

(30) Foreign Application Priority Data
Apr. 12, 2013 (AU) 2013901260

(51) Int. Cl. C02F 1/467; C25B 1/26; C02F 1/68

(52) U.S. Cl. CPC C02F 1/4674; C02F 1/68; C25B 1/26; C02F 2201/4618

(57) ABSTRACT

A water treatment method for improving the water quality of a body of water is disclosed. A water treatment mineral is also disclosed. The water treatment mineral includes a third period electrolyte component comprising magnesium chloride and sodium chloride. The magnesium chloride is more than about 15% by weight of the third period electrolyte. The water treatment mineral may be used with existing water treatment equipment by adjusting the concentration to a level suited to the effective production of hypochlorite anions at a concentration sufficient to sanitize the water.

The method includes adding the water treatment mineral to the body of water at a concentration of about 1200 ppm to about 9600 ppm. The water is passed through an electrolytic cell and an electrical potential is applied, sufficient to produce a predetermined concentration of hypochlorite anions in the mineralized water passing through the electrolytic cell to produce chlorinated water. The chlorinated water is then returned to the body of mineralized water.

### TECHNICAL FIELD

A water treatment method for improving the water quality of a body of water is disclosed. A water treatment mineral is also disclosed. The water treatment method and mineral may be used for improving the water quality in a swimming pool, however, the disclosure is to be broadly interpreted, in that the water treatment method and mineral may be also used for improving the water quality of a pond, aquarium, spa, hot tub, or other body of water.

### BACKGROUND ART

Salt water chlorination is a process that uses dissolved salt as a source of chlorine for the chlorination system. In a conventional salt chlorinated pool there are high levels of sodium chloride, typically in a recommended concentration of about 3000 to 5000 ppm (of Total Dissolved Solids (TDS) of about 4500 to 7500 ppm). A salt water chlorine generator (also known as a chlorinator) includes an electrolysis cell to electrolyse sodium chloride in the water to generate chlorine at the anode of the electrolysis cell. The chlorine reacts with a hydroxide (that is, sodium hydroxide NaOH) in the water (along with hydrogen gas produced at the cathode) to form hypochlorite anions from hypochlorous acid (HClO) and sodium hypochlorite (NaClO), which are sanitising agents commonly used in swimming pools. Electrolytic halogenation of water in swimming pools, spas and the like is an effective method to reduce or minimise the effects of water borne micro-organisms such as bacteria, viruses, algae, parasites and the like.

A problem with the use of salt water chlorination is that scale, principally calcium salts, deposits and builds up on the cathode, thus reducing the efficiency of chlorine production by the electrolysis cell. As a result, periodic cleaning of the electrolysis cell, either manually by removing it from the chlorination system and soaking or scrubbing the electrodes in acids, or automatically by the system including means for injecting a dose of cleaning acid into the cell which remains in the cell for a predetermined time before pumping out and into the body of salt water, is required. Both the manual and automatic cleaning methods, apart from other problems, require consumers to handle acid which is generally not ideal for consumers. Alternatively, complex and expensive circuitry can be installed in the electrolysis cell to reverse the polarity of the electrodes as a means to reduce the scale deposits on the electrodes.

So-called mineral water pools are increasing in popularity as a “spa-like” alternative to conventional sodium chloride salt chlorinated pools. Mineral pools use various blends of minerals instead of, or as well as, sodium chloride. Mineral pools are typically less salty than conventional salt chlorinated pool, with TDS of 3,500 ppm instead of the 6000 ppm typically required in conventional sodium chloride salt chlorinated pool. Thus, mineral water pools generally require less minerals to be added, as well as providing potential therapeutic and health benefits often associated with bathing in mineral water.

Some mineral pool systems require special equipment and complicated chemistry to function. Some systems that claim to be mineral pools use normal salt (i.e. salt which is mostly sodium chloride). Irrespective of the accuracy or otherwise of the description of salt water or mineral water pool systems, the problem remains that the electrolytic cell is specifically matched to a particular electrolyte mix and other water properties and is prone to build-up of scale.

Magnesium compounds, like Epsom salt and such like, are known for their therapeutic and health benefits. Bathing in sea water, which includes dissolved magnesium, and especially in the Dead Sea which is very concentrated sea water, are also known practices for therapeutic and health reasons.

Mixtures including magnesium and other (such as potassium) compounds and solutions have been proposed for use as an alternative to common salt, comprised essentially of sodium chloride, in swimming pools. For example, WO 2008/000029 discloses a method for treating a body of water by forming an electrolyte solution containing soluble halide salts of magnesium and potassium.

However, potassium chloride fluctuates in price and availability due to the mining and agricultural industries which also use potassium. In addition, the complex multi-component mixture disclosed, for example in WO 2008/000029, requires either specialized mixing equipment to process and package the product and may be difficult to produce to a consistent standard using normal equipment. Furthermore, the appropriate concentration of magnesium has not always been established or maintained and there have been problems associated with magnesium dosing methods.

As mentioned above, electrolysis equipment (including chlorinators) and heating equipment are prone to scale formation on active surfaces, including calcium carbonate scale. Scale reduces equipment performance and equipment longevity, making removal of the scale, or avoidance of the build-up of scale, desirable. Solutions of magnesium chloride or magnesium sulfate have been proposed for softening calcium carbonate deposits, also known as scale, although this is not well known. Soaking scale encrusted equipment in magnesium solutions softens the scale deposits and makes removal easier. However, scale softening treatments are not continuous, and are only beneficial during the treatment process.

Magnesium is also a known coagulant or flocculant, and is sometimes referred to as a clarifier. When flocculants are used in pools, the flocs may be captured by the filtration equipment in the water treatment system. Normally, a body of water with high turbidity (cloudiness) would be treated with a dose of a flocculant and the flocs would need to be removed. This is done by vacuuming to waste, sending the flocs and a lot of water to the sewer, waste water or storm water reticulation systems. Flocculants are normally added as isolated doses of clarifier products, normally in response to an existing problem or a contamination episode, such as flooding. The high dose of flocculent results in waste material forming on the bottom of the pool. Magnesium can be added to swimming pools by dosing with magnesium sulfate or with sea salt. However, the concentration of magnesium can be difficult to control, particularly where the capacity of the pool is uncertain and the quality of the sea salt varies.

Also, salt water pools lose salt over time, mostly as a result of the process of backwashing the pool filter, requiring addition of salt several times per year. If dosed with magnesium, a pool will likewise lose magnesium over time, resulting in a change in magnesium concentration.

The above references to background art do not constitute an admission that the art forms a part of the common general knowledge of a person of ordinary skill in the art. The above references are not intended to limit the application of the water treatment method and water treatment mineral as disclosed herein.

### SUMMARY OF THE DISCLOSURE

According to a first aspect, a water treatment method is disclosed. The water treatment method comprises providing a water treatment mineral including a third period electrolyte component comprising magnesium chloride and sodium chloride. The magnesium chloride is more than about 15% by weight of the third period electrolyte. As will be appreciated by those skilled in the art, reference herein to magnesium chloride is a reference to the hexahydrate (magnesium hexahydrate—MgCl₂.6H₂O).

The water treatment mineral is added to a body of water at a concentration of about 1200 ppm to about 9600 ppm (that is, about 1.2 kg to about 9.6 kg per kilolitre of water) to provide a body of mineralized water. A quantity of the body of mineralized water is passed through an electrolytic cell. An electrical potential is then applied to the electrolytic cell sufficient to produce a predetermined concentration of hypochlorite anions in the mineralized water passing through the electrolytic cell to produce chlorinated water. The chlorinated water is then returned to the body of mineralized water. In this regard, the predetermined concentration of hypochlorite anions is considered to be a concentration of hypochlorite anions required to sufficiently improve the water quality of the body of water.

The water treatment method disclosed herein provides a simple means for treating a body of water, particularly in domestic or municipal swimming pools, which does not require either special equipment or special additives. Moreover, the water treatment mineral disclosed herein may be used with existing water treatment equipment by adjusting the concentration to a level suited to the effective production of hypochlorite anions at a concentration sufficient to sanitize the water. As new proprietary equipment is not required, users are not restricted to purchasing specialty, compatible, mineral pool salt products.

In one embodiment, the water treatment mineral may be added to the body of water at a concentration of about 3600 ppm to about 6000 ppm (that is, about 3.6 kg to about 6.0 kg per kilolitre of water).

In another embodiment, the water treatment mineral may be added to the body of water at a concentration of about 3600 ppm to about 4800 ppm (that is, about 3.6 kg to about 4.8 kg per kilolitre of water).

In yet another embodiment, the water treatment mineral may be added to the body of water at a concentration of about 4200 ppm (that is, about 4.2 kg per kilolitre of water).

In one embodiment, the magnesium chloride may be about 16.8% and the sodium chloride may be about 83.2% by weight of the third period electrolyte component.

Other substantially soluble components may be present in the water treatment mineral. However, it will be appreciated that such other components are limited in concentration to a level which provides substantially no interference with the electrolytic step in the method.

When the body of water has a high level of hardness, or in the case of concrete swimming pools, where the build-up of scale on the electrodes of an electrolytic cell can occur, use of the water treatment method and water treatment mineral disclosed herein, may reduce the rate of, or eliminate, scale build-up. This may be due to the flocculation or clarifying effect of magnesium hereinbefore described.

Thus, normal operation of water treatment equipment could remove flocs as they form, before a consumer would need to perform additional cleaning and maintenance processes. Having a smaller dose of flocculant, but continuously present, may provide simplify, for example, pool maintenance for the pool owner and maintain performance charateristics of the electrolytic cell. The inclusion of magnesium in a water treatment mineral, according to the water treatment method and water treatment mineral disclosed herein, provides that the dose of magnesium is controlled and therefore the concentration of magnesium in the water can be controlled. This can assist in assuring correct dosages, stable and consistent operation, and simplicity for the pool owner.

According to a second aspect, a water treatment mineral is disclosed. The water treatment mineral comprises a third period electrolyte component comprising magnesium chloride and sodium chloride, the magnesium chloride being more than about 15% by weight of the third period electrolyte component. As will be appreciated by those skilled in the art, reference herein to magnesium chloride is a reference to the hexahydrate (magnesium hexahydrate—MgCl₂.6H₂O).

In one embodiment, the magnesium chloride may be about 16.8% by weight, and the sodium chloride may be about 83.2% by weight, of the third period electrolyte component.

According to a third aspect, a water treatment method is disclosed. The water treatment method of the third aspect comprises providing a water treatment mineral including a third period electrolyte component comprising magnesium chloride. The water treatment mineral is added to a body of water to provide a body of mineralized water having a magnesium chloride concentration of about 180 ppm to about 1440 ppm. In other words, the water treatment mineral is added to a body of water to provide a body of mineralized water having a magnesium ion concentration of about 20 ppm to about 140 ppm. As will be appreciated by those skilled in the art, reference herein to magnesium chloride is a reference to the hexahydrate (magnesium hexahydrate—MgCl₂.6H₂O).

A quantity of the body of mineralized water is passed through an electrolytic cell. An electrical potential is then applied to the electrolytic cell sufficient to produce a predetermined concentration of hypochlorite anions in the mineralized water passing through the electrolytic cell to produce chlorinated water. The chlorinated water is then returned to the body of mineralized water. In this regard, the predetermined concentration of hypochlorite anions in the mineralized water passing through the electrolytic cell to produce chlorinated water is considered to be a concentration of hypochlorite anions required to sufficiently improve the water quality of the body of water.

In this regard, the method of the third aspect may be employed with a conventional salt water pool (i.e. body of water) to transform the pool to a so-called mineral pool. As such, the water treatment mineral may consist essentially only of magnesium chloride.

In one embodiment of the third aspect, the water treatment mineral may be added to the body of water to provide a body of mineralized water having a magnesium chloride concentration of about 540 ppm to about 1010 ppm. In other words, the water treatment mineral may be added to a body of water to provide a body of mineralized water having a magnesium ion concentration of about 50 ppm to about 100 ppm.

In another embodiment of the third aspect, the water treatment mineral may be added to the body of water to provide a body of mineralized water having a magnesium chloride concentration of about 540 ppm to about 810 ppm. In other words, the water treatment mineral may be added to a body of water to provide a body of mineralized water having a magnesium ion concentration of about 50 ppm to about 80 ppm.

In yet another embodiment of the third aspect, the water treatment mineral may be added to the body of water to provide a body of mineralized water having a magnesium chloride concentration of approximately 710 ppm. In other words, the water treatment mineral may be added to a body of water to provide a body of mineralized water having a magnesium ion concentration of about 70 ppm.

According to a fourth aspect, a water treatment method is disclosed. The water treatment method of the fourth aspect includes testing a body of water to determine a sodium chloride concentration thereof. An amount of magnesium chloride to be added to the body of water, so as to produce an effective amount of hypochlorite anions at a concentration sufficient to sanitize the body of water, is calculated and the amount of magnesium chloride is added to the body of water to form a mineralized body of water. A quantity of the body of mineralised water is passed through an electrolytic cell and an electrical potential applied thereto to produce chlorinated water. The chlorinated water is returned to the mineralized body of water.

In one embodiment of the fourth aspect, the amount of magnesium chloride to be added to the body of water may be such that the combined concentration of sodium chloride and magnesium chloride is about 1200 ppm to about 9600 ppm. As will be appreciated by those skilled in the art, reference herein to magnesium chloride is a reference to the hexahydrate (magnesium hexahydrate—MgCl₂.6H₂O).

In another embodiment of the fourth aspect, the magnesium chloride concentration may be about 180 ppm to about 1440 ppm. In other words, the mineralized body of water may have a magnesium ion concentration of about 20 ppm to about 140 ppm.

According to a fifth aspect, a water treatment method is disclosed. The water treatment method comprises adding, to a body of water, a water treatment mineral comprising magnesium chloride and sodium chloride, the magnesium chloride being more than about 15% by weight. The mineral is added at a concentration that has been adjusted to a level that is suited to the effective production of hypochlorite anions at a concentration sufficient to sanitize the body of water. As will be appreciated by those skilled in the art, reference herein to magnesium chloride is a reference to the hexahydrate (magnesium hexahydrate—MgCl₂.6H₂O).

In an embodiment of the water treatment method of the first, third, fourth or fifth aspects, the body of water may comprise a domestic or municipal swimming pool.

In another an embodiment of the water treatment method of the first, third, fourth or fifth aspects, the body of water to which the mineral is added may comprise sodium chloride.

The water treatment mineral disclosed herein may be readily sourced from mineral deposits and cost effective to produce. Some existing mineral salt products use potassium chloride, which fluctuates in price and availability due to the mining and agricultural industries which also use potassium. Complex multi-component mixtures require either specialized mixing equipment to process and package the product, or are difficult to produce to a consistent standard using normal equipment. Simplifying the mixture to essentially magnesium chloride and sodium chloride, or essentially magnesium chloride, simplifies sourcing of raw materials and the requirements for equipment to properly mix and package the disclosed water treatment mineral. Furthermore, reducing the number of different substances added to the water may make chemical balancing of the water easier. Moreover, the constituent components of the disclosed water treatment mineral have been shown to improve bather comfort, even in low concentrations.

A body of mineralized water prepared according to the method of the first, third, fourth or fifth aspects is also disclosed.

Although the water treatment method and water treatment mineral has been described with reference to specific examples, it will be appreciated by persons skilled in the art that the water treatment method and water treatment mineral may be embodied in other forms within the broad scope and ambit of the present disclosure.

### EXAMPLES

Non-limiting Examples of various water treatment methods and minerals, in use, will now be described to illustrate how the water treatment methods and minerals may be applied, for example, to improve the water quality of a domestic swimming pool. It should, however, be appreciated that the water treatment methods and minerals can be used to improve the water quality of other bodies of water such as spas, ponds, aquariums, hot tubs, etc.

Examples 1-12 are non-limiting Examples which illustrate a method of sanitisation of a swimming pool using a water treatment mineral comprising from about 1200 ppm to about 9600 ppm of a third period electrolyte component comprising magnesium chloride and sodium chloride salts. The concentration range of magnesium chloride hexahydrate (MgCl₂.6H₂O) in the water treatment mineral is from about 180 ppm to about 1440 ppm. The concentration range of sodium chloride (NaCl) in the water treatment mineral is from about 1020 ppm to about 8160 ppm.

It will be appreciated that the water treatment mineral may be added to the body of water in different concentrations, and that these concentrations may be adjusted to suit a particular system and/or user thereof. It will also be appreciated that the weight percentages of the third period electrolyte components of the water treatment mineral may also be adjusted to suit a particular system and/or user thereof.

It was discovered that, when the water treatment mineral of the present disclosure is added to a body of water at a concentration of about 1200 ppm to about 9600 ppm, it is possible to maintain adequate chlorine levels for efficient sanitisation of a swimming pool. In some embodiments, this is significantly less than the recommended concentration of about 6000 ppm of NaCl in a conventional salt chlorinated pool. Associated advantages may include lower chemical usage with resulting cost savings, reduced environmental damage, and at least partly reduced disinfection by-products including chloramines and trihalomethanes.

In addition, in the Examples disclosed herein, it was evident that the use of magnesium chloride hexahydrate in the range of about 180 ppm to about 1440 ppm in the water treatment mineral had the effect of reducing scale deposit on the electrolysis equipment, with the magnesium ion acting as a scale softening agent. Further, as the magnesium was constantly present in the water, the magnesium acted as a continuous softening treatment. This reduced the time and expense of replacing and/or rigorously cleaning the electrolysis equipment in a salt water pool.

Whilst the following Examples only refer to the presence of magnesium chloride and sodium chloride, other substantially soluble components may be present in the water treatment mineral. However, it will be appreciated that such other components are limited in concentration to a level which provides substantially no interference with the electrolytic step in the method.

### Example 1

MgCl₂.6H₂O: 180 ppm (15 wt %)

NaCl: 1020 ppm (85 wt %)

Total concentration of water treatment mineral: 1200 ppm

### Example 2

MgCl₂.6H₂O: 1440 ppm (15 wt %)

NaCl: 8160 ppm (85 wt %)

Total concentration of water treatment mineral: 9600 ppm

### Example 3

MgCl₂.6H₂O: 540 ppm (15 wt %)

NaCl: 3060 ppm (85 wt %)

Total concentration of water treatment mineral: 3600 ppm

### Example 4

MgCl₂.6H₂O: 900 ppm (15 wt %)

NaCl: 5100 ppm (85 wt %)

Total concentration of water treatment mineral: 6000 ppm

### Example 5

MgCl₂.6H₂O: 720 ppm (15 wt %)

NaCl: 4080 ppm (85 wt %)

Total concentration of water treatment mineral: 4800 ppm

### Example 6

MgCl₂.6H₂O: 630 ppm (15 wt %)

NaCl: 3570 ppm (85 wt %)

Total concentration of water treatment mineral: 4200 ppm

### Example 7

MgCl₂.6H₂O: 201.6 ppm (16.8 wt %)

NaCl: 998.4 ppm (83.2 wt %)

Total concentration of water treatment mineral: 1200 ppm

### Example 8

MgCl₂.6H₂O: 1612.8 ppm (16.8 wt %)

NaCl: 7987.2 ppm (83.2 wt %)

Total concentration of water treatment mineral: 9600 ppm

### Example 9

MgCl₂.6H₂O: 604.8 ppm (16.8 wt %)

NaCl: 2995.2 ppm (83.2 wt %)

Total concentration of water treatment mineral: 3600 ppm

### Example 10

MgCl₂.6H₂O: 1008 ppm (16.8 wt %)

NaCl: 4992 ppm (83.2 wt %)

Total concentration of water treatment mineral: 6000 ppm

### Example 11

MgCl₂.6H₂O: 806.4 ppm (16.8 wt %)

NaCl: 3993.6 ppm (83.2 wt %)

Total concentration of water treatment mineral: 4800 ppm

### Example 12

MgCl₂.6H₂O: 705.6 ppm (16.8 wt %)

NaCl: 3494.4 ppm (83.2 wt %)

Total concentration of water treatment mineral: 4200 ppm

Table 1 shows a summary of Examples 1 to 12, based on the Total Weight (kg) pf the water treatment mineral per kiloliter of water. This Table also provides the approximate calculated magnesium ion concentration for the Examples given.

TABLE 1

| | | Magnesium | | | | | |
|---|---|---|---|---|---|---|---|
| | | Chloride | Sodium | | | MgCl₂ | Mg²⁺ |
| | Total | Hexahydrate | Chloride | Volume | MgCl₂•6H₂O | Conc. | Conc. |
| | Weight (kg) | (kg) | (kg) | (L) | Conc. (mg/L) | (mg/L) | (mg/L) |
| 1 | 1.2 | 0.18 | 1.02 | 1000 | 180 | 83.7 | 18 |
| 2 | 9.6 | 1.44 | 8.16 | 1000 | 1440 | 669.6 | 144 |
| 3 | 3.6 | 0.54 | 3.06 | 1000 | 540 | 251.1 | 54 |
| 4 | 6 | 0.9 | 5.1 | 1000 | 900 | 418.5 | 90 |
| 5 | 4.8 | 0.72 | 4.08 | 1000 | 720 | 334.8 | 72 |
| 6 | 4.2 | 0.63 | 3.57 | 1000 | 630 | 292.95 | 63 |
| 7 | 1.2 | 0.2016 | 0.9984 | 1000 | 201.6 | 93.74 | 20.16 |
| 8 | 9.6 | 1.6128 | 7.9872 | 1000 | 1612.8 | 749.95 | 161.28 |
| 9 | 3.6 | 0.6048 | 2.9952 | 1000 | 604.8 | 281.23 | 60.48 |
| 10 | 6 | 1.008 | 4.992 | 1000 | 1008 | 468.72 | 100.8 |
| 11 | 4.8 | 0.8064 | 3.9936 | 1000 | 806.4 | 374.98 | 80.64 |
| 12 | 4.2 | 0.7056 | 3.4944 | 1000 | 705.6 | 328.10 | 70.56 |

### Example 13

A 10 kg container of water treatment mineral was prepared. The container comprised more than about 15% by weight of magnesium chloride (hexahydrate) and less than about 85% by weight of sodium chloride. In this regard, the 10 kg container comprised more than about 1.5 kg of magnesium chloride (hexahydrate) and less than about 8.5 kg of sodium chloride.

Whilst a number of specific embodiments have been described, it should be appreciated that the water treatment method and mineral may be embodied in many other forms.

In the claims which follow, and in the preceding description, except where the context requires otherwise due to express language or necessary implication, the word “comprise” and variations such as “comprises” or “comprising” are used in an inclusive sense, i.e. to specify the presence of the stated features but not to preclude the presence or addition of further features in various embodiments of the water treatment products and method as disclosed herein.

1. A water treatment method including the steps of:
providing a water treatment mineral including a third period electrolyte component comprising magnesium chloride and sodium chloride, the magnesium chloride being more than about 15% by weight of the third period electrolyte component;
adding the water treatment mineral to a body of water at a concentration of about 1200 ppm to about 9600 ppm to provide a body of mineralized water; and
passing a quantity of the body of mineralized water through an electrolytic cell;
applying an electrical potential to the electrolytic cell sufficient to produce a predetermined concentration of hypochlorite anions in the mineralized water passing through the electrolytic cell to produce chlorinated water; and
returning the chlorinated water to the body of mineralized water.

2. A water treatment method as claimed in claim 1 wherein the water treatment mineral is added to the body of water at a concentration of about 3600 ppm to about 6000 ppm.

3. A water treatment method as claimed in claim 2 wherein the water treatment mineral is added to the body of water at a concentration of about 3600 ppm to about 4800 ppm.

4. A water treatment method as claimed in claim 3 wherein the water treatment mineral is added to the body of water at a concentration of about 4200 ppm.

5. A water treatment method as claimed in claim 1 wherein the magnesium chloride is about 16.8% and the sodium chloride is about 83.2% by weight of the third period electrolyte component.

6. A water treatment mineral including:
a third period electrolyte component comprising magnesium chloride and sodium chloride, the magnesium chloride being more than about 15% by weight of the third period electrolyte component.

7. The water treatment mineral as claimed in claim 6 wherein the magnesium chloride is about 16.8% and the sodium chloride is about 83.2% by weight of the third period electrolyte component.

8-16. (canceled)

17. A water treatment method, including the steps of:
testing a body of water to determine a sodium chloride concentration thereof;
calculating an amount of magnesium chloride to be added to the body of water so as to produce an effective amount of hypochlorite anions at a concentration sufficient to sanitize the body of water;
adding the amount of magnesium chloride to the body of water to form a mineralized body of water;
passing a quantity of the body of mineralised water through an electrolytic cell and applying an electrical potential thereto to produce chlorinated water; and
returning the chlorinated water to the mineralized body of water.

18. A water treatment method as claimed in claim 17 wherein the amount of magnesium chloride to be added to the body of water is such that the combined concentration of sodium chloride and magnesium chloride is about 1200 ppm to about 9600 ppm.

19. A water treatment method as claimed in claim 18 wherein the magnesium chloride concentration is about 180 ppm to about 1440 ppm.

20. A water treatment method as claimed in claim 18 wherein the mineralized body of water has a magnesium ion concentration of about 20 ppm to about 140 ppm.

21. A water treatment method as claimed in claim 1, wherein the water treatment mineral is added to the body of water at a concentration that has been adjusted to a level that is suited to the effective production of hypochlorite anions at a concentration sufficient to sanitize the body of water.

22. A water treatment method as claimed in claim 1, wherein the body of water comprises a domestic or municipal swimming pool.

23. A water treatment method as claimed in claim 1, wherein the body of water to which the mineral is added comprises sodium chloride.

24. (canceled)

25. A water treatment method as claimed in claim 17, wherein the body of water comprises a domestic or municipal swimming pool.
